(19) United States
(12) Patent Application Publication
(10) Pub. No.: US 2008/0304401 A1
(43) Pub. Date: Dec. 11, 2008

(54) INFORMATION RECORDING MEDIUM, INFORMATION RECORDING METHOD, AND INFORMATION REPRODUCING METHOD

(75) Inventors: Hideo Ando, Hino-shi (JP); Hisashi Yamada, Yokohama-shi (JP); Seiji Morita, Yokohama-shi (JP); Koji Takazawa, Tokyo (JP); Naomasa Nakamura, Yokohama-shi (JP); Kazuo Watabe, Yokohama-shi (JP); Nobuaki Kaji, Yokohama-shi (JP); Masahiko Mawatari, Yokohama-shi (JP); Nobuhisa Yoshida, Kamakura-shi (JP); Koichi Nagai, Chigasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/969,732

(22) Filed: Jan. 4, 2008

(30) Foreign Application Priority Data
Jan. 16, 2007 (JP) 2007-007247

(51) Int. Cl. G11B 3/70

(52) U.S. Cl. 369/275.4

(57) ABSTRACT

According to one embodiment, an optical information recording medium includes pre-grooves with an irregular shape and lands each of which is sandwiched between the pre-grooves adjacent to each other, where the pre-grooves and lands are defined on an interface between a recording layer and a light reflection layer in a recording film, where the recording film includes a light reflectivity that enables reproduction with light of 650±5 nm, the recording layer includes a recording sensitivity with respect to light by a wavelength shorter than 650±5 nm, and a recording mark can be formed on the pre-groove by using light with a wavelength shorter than 650±5 nm.

### CROSS-REFERENCE TO RELATED APPLICATIONS

This application is based upon and claims the benefit of priority from Japanese Patent Application No. 2007-007247, filed Jan. 16, 2007, the entire contents of which are incorporated herein by reference.

### BACKGROUND

1. Field

One embodiment of the invention relates to an information recording medium, an information recording method, and an information reproducing method. More particularly, the present invention relates to an information recording medium having a shape and a dimension of a pre-groove and a shape and a dimension of a land pre-pit which enable acquiring a track deviation detection signal and a land pre-pit detection signal with respect to recording light and also enable reducing an influence of the pre-groove or the pre-pit with respect to reproducing light, a method of recording information in this recording medium, and a method of reproducing information from this recording medium.

2. Description of the Related Art

A long time has passed since an information recording medium, i.e., an optical disc in which information can be recorded and reproduced by using a laser beam was put to practical use. For example, in an optical disc with a diameter of 12 cm conforming to the DVD standard, pictures having a standard image quality can be recorded for several hours. Further, in a reproduction-only optical disc, picture software or content can be recorded in a short time based on press working or molding. It is to be noted that a land pre-pit and a groove track (a pre-groove) are formed in an optical disc in which information can be written (write-once) or erased (rewriting). In a currently commercially available DVD-R disc or a DVD-RW disc, address information is previously recorded by using a land pre-pit, and a recording mark is formed on a wobbled pre-groove.

Japanese Patent Application Publication (KOKAI) No. 2001-266362 discloses that a) a large detection signal can be obtained from a land pre-pit in order to assure reproduction reliability from address information recorded in the land pre-pit and b) a large track deviation detection signal is obtained from a pre-groove in order to assure high tracking stability in formation of a recording mark when recording a new recording mark with respect to an information storage medium where the pre-groove and the land pre-pit are present.

In the example disclosed in above publication, since a wavelength of a laser beam used to record the recording mark is equal to a wavelength of a laser beam used to reproduce information from the recording mark, there are the following problems:

1. reproduction signal characteristics from the recording mark are degraded because a crosstalk signal from the land pre-pit is mixed in a reproduction signal from the recording mark, and reproduction reliability from the recording mark is greatly reduced;

2. track deviation characteristics based on a DPD (Differential Phase Detect) method are degraded because of an influence of diffracted light from the pre-groove, and track deviation detection stability from the recording mark is reduced; and

3. a reproduction signal amplitude from the recording mark is decreased because of occurrence of a reduction in a DC level from the pre-groove in reproduction, and reproduction reliability from the recording mark is greatly reduced.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of a structure of a write-once information recording medium according to an embodiment of the present invention;

FIG. 2 is an exemplary diagram showing an example of a cross-sectional structure of an information recording medium different from the write-once information recording medium according to an embodiment of the invention;

FIGS. 3A to 3C are exemplary diagrams, each showing an example of a basic principle used in an embodiment of the present invention, according to an embodiment of the invention;

FIG. 4 is a graph showing an example of a relationship between a groove depth and a push-pull signal amplitude when light having a wavelength of 650 nm is condensed by an objective lens having an NA of 0.6 according to an embodiment of the present invention;

FIG. 5 is a graph showing examples of a relationship between a groove depth and a push-pull signal amplitude when light having a wavelength of 405 nm is condensed by an objective lens having an NA of 0.65;

FIG. 6 is a graph showing an example of a pre-groove depth range satisfying conditions which can reduce a push-pull signal amplitude when light having a wavelength of 650 nm is condensed by an objective lens having an NA of 0.6 and can increase the push-pull signal amplitude when light having a wavelength of 405 nm is condensed (a relationship between the push-pull signal amplitude and a groove depth when the light having the wavelength of 405 nm is condensed by objective lenses having different NAs in a state where the push-pull signal amplitude based on the light having the wavelength of 650 nm is set to a predetermined intensity) according to an embodiment of the invention;

FIG. 7 is a graph showing an example of light absorption spectral characteristics of an L-to-H type organic dye recording material according to an embodiment of the invention;

FIG. 8 is a graph showing an example of light absorption spectral characteristics of the L-to-H type organic dye recording material according to an embodiment of the invention;

FIG. 9 is a graph showing an example of light absorption spectral characteristics of an H-to-L type organic dye recording material according to an embodiment of the invention;

FIGS. 10A and 10B are exemplary diagrams, each showing an example of a structure of a land pre-pit of the write-once information recording medium shown in FIG. 1 or 2, according to an embodiment of the present invention;

FIG. 11 is an exemplary diagram showing an example of a structure of a recording region in the write-once information recording medium shown in FIG. 2, according to an embodiment of the invention;

FIGS. 12A to 12D are exemplary diagrams, each showing an example of a data structure of the recording region in the write-once information recording medium shown in FIG. 2, according to an embodiment of the invention;

FIG. 13 is an exemplary diagram showing an example of physical format information and R physical format information having the data structure shown in FIGS. 12A to 12D, according to an embodiment of the invention;

FIG. 14 is an exemplary diagram showing examples of physical format information and R physical format information in a data region DTA having the data structure shown in FIG. 13, according to an embodiment of the invention;

FIG. 15 is an exemplary diagram showing examples of a current picture information distribution system according to an embodiment of the invention;

FIG. 16 is an exemplary diagram showing examples of a picture information distribution system achieved by using the information recording medium of the present invention according to an embodiment of the invention; and

FIG. 17 is an exemplary diagram showing an example of a picture information distribution system achieved by using the information recording medium of the present invention according to an embodiment of the invention.

### DETAILED DESCRIPTION

Various embodiments according to the invention will be described hereinafter with reference to the accompanying drawings. In general, according to one embodiment of the invention, information storage medium comprising: a recording film including a recording layer and a light reflection layer; and pre-grooves and lands each of which is sandwiched between the pre-grooves adjacent to each other, the pre-grooves and the lands being forming on an interface between the recording layer and the light reflection layer, wherein the recording film includes a light reflectivity which enables reproduction with light of 650±5 nm, and wherein the recording layer includes a recording sensitivity with respect to light with a wavelength shorter than 650±5 nm, and a recording mark is configured to be formed on the pre-groove of the recording layer by using light of a wavelength shorter than 650±5 nm.

Embodiments according to the present invention will now be explained hereinafter in detail with reference to the accompanying drawings.

FIG. 1 shows a cross-sectional structure of a current write-once information storage medium (a current DVD-R disc).

In the current DVD-R disc, an organic-dye-based material as a material of a recording layer 103 is often formed on a transparent substrate 101 by spinner coating, and a light reflection layer 102 made of an inorganic material (which is often a metal), e.g., Al or Au is formed to be adjacent to the recording layer 103. An irregular shape of a pre-groove 107 or a land pre-pit 108 on the recording layer 103 side is reflected to produce each step dc on a surface of the light reflection layer 102.

In a current rewritable information recording medium (a current DVD-RW disc), a transparent substrate 101 has a structure similar to that of the DVD-R disc depicted in FIG. 1, and a pre-groove 107 or a land pre-pit 108 is formed. However, a phase change recording material is used for a recording layer 103, and forming a recording mark based on a phase change of the recording layer is different from the current DVD-R disc.

Therefore, in the DVD-R disc and the DVD-RW disc, not only materials of the recording layers 103 are different but also the insides of the recording layers 103 are formed of a plurality of layers having different materials (a laminated structure including an upper protection layer and a lower protection layer sandwiching the recording layer therebetween, an underlying layer, and others).

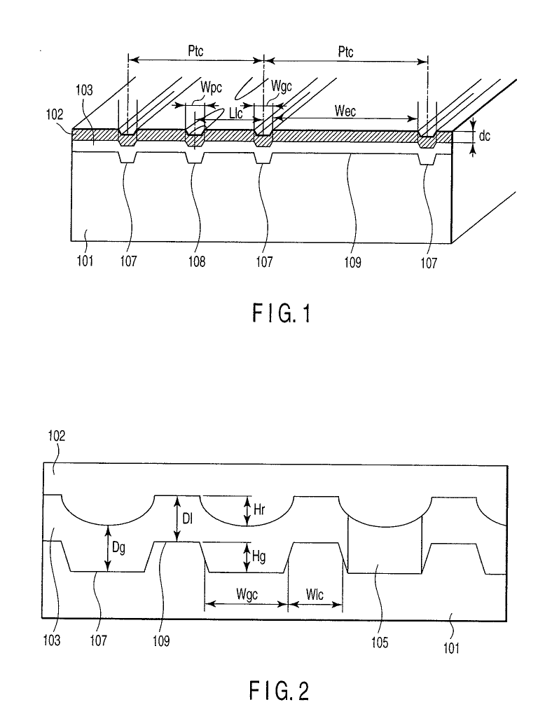

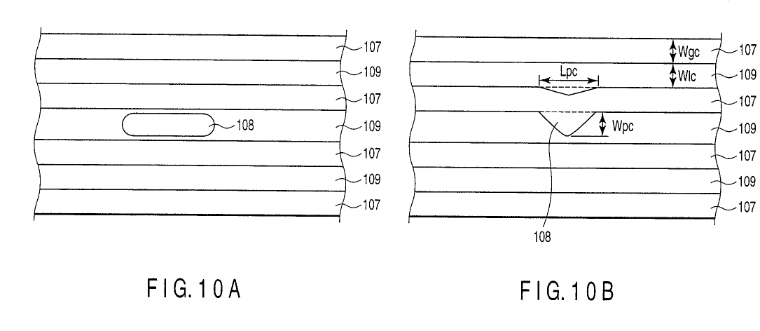

FIGS. 2 and 10B show a fine structure in the information storage medium according to this embodiment. It is to be noted that the land pre-pit 108 depicted in FIG. 10B is omitted in FIG. 2.

A material of the recording layer 103 in the write-once information storage medium according to this embodiment, a later-explained organic-dye-based material is used. Furthermore, a light recording layer 102 made of an inorganic material, e.g., Ag or an Ag alloy is formed to be adjacent to the recording layer 103. It is to be noted that the irregular shape is provided on an interface of the light reflection layer 102 on an opposite side in the information recording medium depicted in FIG. 2 like FIG. 1, but a cross section cutting across the center of the light reflection layer 102 is shown since a thickness of the light reflection layer 2 is sufficiently large, and the irregular shape on the interface of the opposite side is omitted in the drawing.

On the interface between the recording layer 103 and the light reflection layer 102, the step has an irregular shape denoted by Hr in the pre-groove 107 or the land pre-pit 108.

Although an example where an organic-dye-based material is used for the recording layer 103 in the write-once information storage medium according to this embodiment will be explained below, the present invention is not restricted thereto, and an inorganic material may be used as a material of the recording layer 103.

An example of using an inorganic material as a material of the recording layer 103, a phase change (a phase change is utilized to form a recording mark 105) recording material such as a chalcogenide-based material may be used, or a material such as Te—C which directly makes a hole to form the recording mark 105 may be used, or different types of inorganic layers may be laminated to form a mixture or a compound in the recording mark 105 based on thermal diffusion.

In case of the information storage medium according to this embodiment having the cross-sectional structure depicted in FIG. 2, a track deviation detection signal or a detection signal from the land pre-pit 108 using a push-pull method can be obtained by diffraction/interference of light reflected on the interface between the recording layer 103 and the light reflection layer 102 having the step Hr.

A basic principle of the present invention will now be explained.

The embodiment according to the present invention has great characteristics in that a usable wavelength is changed depending on recording light and reproducing light for a recording/reproducing apparatus and that the information storage medium which guarantees excellent recording characteristics and reproduction characteristics with respect to the recording light and the reproducing light having different wavelengths.

Moreover, setting a pre-groove shape and dimension and a land pre-pit shape and a dimension which enable acquiring a track deviation detection signal and a land pre-pit detection signal with respect to the recording light and prevent the pre-groove or the pre-pit from substantially having no influence on the reproducing light has the following characteristics.

In the current DVD-R disc or DVD-RW disc, 650±5 nm is premised as a wavelength of the reproducing light.

In the information storage medium according to this embodiment, reproduction is enabled with light having a wavelength of 650±5 nm in order to assure reproduction compatibility between the current DVD-R disc and DVD-RW disc.

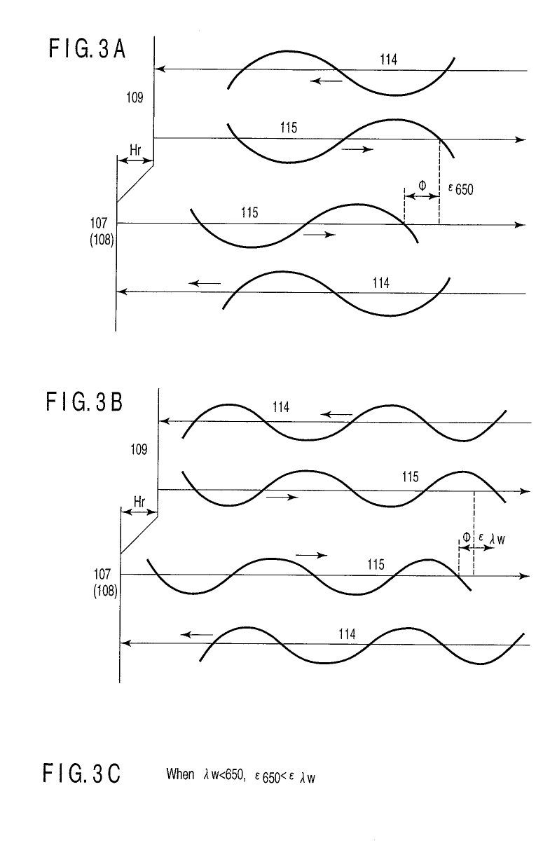

A relationship between a wavelength of the recording light and a pre-groove dimension and a land pre-pit dimension which enable obtaining the track deviation detection signal and the land pre-pit detection signal with respect to the recording light and substantially prevent the pre-groove or the pre-pit from substantially having no influence on the reproducing light (the light having the wavelength of 650±5 nm) will now be explained with reference to FIG. 3.

As explained above, the track deviation detection signal or the detection signal from the land pre-pit 108 using the push-pull method can be obtained based on diffraction/interference of light reflected on the interface (see FIG. 2) between the recording layer 103 and the light reflection layer 102.

An example where both the pre-groove 107 or the land pre-pit 108 having the step Hr and the land 109 are irradiated with incident lights 104 having different wavelengths will now be explained.

FIG. 3A shows an example where reproducing light having a wavelength of 650 nm is applied, and ε₆₅₀ represents a phase difference produced in reflected lights 115 vertically reflected with respect to the pre-groove 107 or the land pre-pit 108 and the land 109 by the step Hr.

FIG. 3B shows an example where recording light having a wavelength λw different from that of the reproducing light is applied. It is assumed that ε_{λw} is a phase difference produced in reflected lights based on the recording light by the step Hr.

As shown in FIG. 3C, if step amounts Hr are equal to each other, a relationship of ε₆₅₀<ε_{λw} is achieved when λw<650 nm.

If ε₆₅₀<π and ε_{λw}<π, an interference amount between the reflected lights 115 is large when the phase difference ε is large, thereby obtaining the large track deviation detection signal and land pre-pit detection signal.

On the other hand, the inference between the reflected lights 115a is small when the phase difference ε is small, and an adverse influence of the pre-groove or the pre-pit (degradation in reproduction signal characteristics from the recording mark due to a crosstalk signal from the land pre-pit or a reduction in the DC level from the pre-groove explained the section of problems in the conventional technology) hardly emerges (degradation in characteristics of the reproduction signal is small).

Therefore, this embodiment is significantly characterized in that the wavelength λw of the recording light is shortened (λw<650 nm) with respect to the wavelength (650±5 nm) of the reproducing light so that the track deviation detection signal and the land pre-pit detection signal can be obtained with respect to the recording light and the reproducing light is hardly affected by the pre-groove or the pre-pit.

As the wavelength λw used for the recording light, an arbitrary value can be taken as long as it is smaller than 650 nm.

However, since a semiconductor laser beam source having a wavelength of 405 nm is used for an HD DVD disc or a BD (Blu-Ray disc), likewise using the beam source having a wavelength of 405 nm enables inexpensively manufacturing a recording optical head.

An optical head mounted in a recording apparatus will now be explained.

A light condensing spot condensed on the recording layer 103 performs tracing (tracking) on the pre-groove 107 depicted in FIG. 1.

Therefore, if the light condensing spot has an extremely small size, i.e., if it has a fixed size or above, a larger detection signal can be obtained from the land pre-pit 108 when a ratio of a distance Llc from the center of the pre-groove 107 to the center of the land pre-pit 108 with respect to the light condensing spot size is large.

Moreover, the numerical aperture NA of an objective lens utilized in a reproduction optical head for the current DVD-R disc or DVD-RW disc is specified as 0.60±0.01.

It is known that the size of the light condensing spot condensed on the recording layer 103 is proportional to λ/NA, where λ is the wavelength of light.

Therefore, in this embodiment, the size of the light condensing spot condensed on the recording layer 103 is reduced to increase the land pre-pit detection signal by increasing the NA of the objective lens in the optical head mounted in the recording apparatus beyond that of the current reproduction optical head.

Although the NA of the objective lens in the optical head mounted in the recording apparatus must be greater than 0.6 as the NA of the objective lens in the reproduction optical head, 0.65 or greater is desirable.

Additionally, when NA=0.70 or above or NA=0.83 or above is set, the larger land pre-pit detection signal can be obtained.

Although the recording apparatus and the reproduction apparatus are distinguished from each other in the above explanation for better understanding, this embodiment is not restricted thereto, both the recording optical head and the reproduction optical head may be prepared in the same apparatus, or the same optical head in the same apparatus may include a 405-nm beam source for recording, a recording objective lens having an NA of 0.65, a 650-nm beam source for reproduction, and a reproduction objective lens having the NA of 0.60.

In the embodiment of the present invention is not restricted thereto, and the objective lens having the NA of 0.65 alone may be used and a detachable aperture (an aperture limiting shutter) may be arranged in a light supplying system so that the NA becomes 0.60 in reproduction.

In this embodiment, a beam source wavelength of the recording optical head in the recording apparatus is set to be shorter than 650 nm (desirably, 405 nm) and the NA of the objective lens used in the recording optical head is set to be larger than 0.60 (desirably, NA≧0.65) in place of setting the wavelength to 650 nm and the NA to 0.60 in the reproduction optical head in the reproduction apparatus in accordance with a current DVD player (aiming to assure compatibility), thereby increasing a track deviation detection signal amount and a land pre-pit detection signal amount (based on the push-pull method) in recording beyond those in reproduction.

An influence of the land pre-pit detection signal in reproduction can be reduced and the track deviation detection signal amount in reproduction can be decreased to prevent a DC level from the pre-groove 107 from lowering by relatively increasing the track deviation detection signal amount and the land pre-pit detection signal amount in this manner, thus avoiding a reduction in reliability of reproduction characteristics from the recording mark in reproduction.

Therefore, this embodiment is characterized in that a difference in wavelength between the recording light and the reproducing light is utilized to specify the ranges of a shape and a dimension of the pre-groove 107 and a shape and a dimension of the land pre-pit 108.

As explained in conjunction with FIG. 2, the land pre-pit detection signal amount and the track deviation detection signal amount are determined based on light reflected on the interface between the recording layer 103 and the light reflection layer 102 (the reproducing light in this example).

Assuming that the refractive index of the reproducing light having a wavelength of 650±5 nm in the recording layer 103 is n₆₅₀, the maximum land pre-set detection signal and the maximum track deviation detection signal are detected when a depth (the step) Hr of the pre-groove equal to a depth (the step) of the land pre-pit is 650/(8·n₆₅₀) nm.

Therefore, as a condition for avoiding an influence in reproduction, the depth (the step) of the pre-groove and the depth (the step) Hr of the land pre-pit are set to 650/(16·n₆₅₀) nm or below which is half the above-explained value in this embodiment.

Further, as a condition for further circumventing the influence, it is desirable to set these depths to 650/(32·n₆₅₀) nm or below which is half the above value.

The depth (the step) Hr of the pre-groove on the interface between the recording layer 103 and the light reflection layer 102 will now be examined in more detailed.

The reflected light 115 shown in FIGS. 3A and 3B passes through the objective lens, and then its light quantity is detected by a two-split detector arranged in a radial direction of the information storage medium.

Signal amounts detected by respective detection cells in this photodetector are represented as I₁ and I₂.

In the current DVD-R standard, the range of the track deviation detection signal is defined as follows:

0.22<|I1−I2|ac/|I1+I2|dc<0.44 (1).

Therefore, as a condition for reducing an influence of the track deviation detection signal in reproduction and avoiding a reduction in a DC level from the pre-groove 107, the range of detection signal characteristics in reproduction is defined as follows in this embodiment:

|I1−I2|ac/|I1+I2|dc<0.22 (2).

The above Expression (2) is the minimum condition. However, as a condition enabling further reducing the influence of the track deviation detection signal in reproduction and avoiding a reduction in a DC level from the pre-groove 107, the following expression obtained by narrowing the condition of Expression (2) to ½ is desirable:

|I1−I2|ac/|I1+I2|dc<0.11 (3).

Additionally, in the current DVD-R standard, as the range of the land pre-pit detection signal is defined as follows:

0.18<|I1−I2|o−p/|I1+I2|dc<0.28 (4).

Therefore, as a condition for reducing an influence of crosstalk from the land pre-pit during reproduction, the range of detection signal characteristics in reproduction is determined as follows in this embodiment:

|I1−I2|o−p/|I1+I2|dc<0.18 (5).

Likewise, as a condition allowing for a margin, the following expression obtained by narrowing the condition of Expression (5) to ½ is more desirable:

|I1−I2|o−p/|I1+I2|dc<0.09 (6).

In the above expressions, a direct-current component with respect to I1+I2 as a sum of signals obtained by two detection cells when the light condensing spots cuts across the pre-groove 107 and the land 109 more than once is defined as |I1+I2|dc, and a differential amplitude (an alternating-current component) of signals obtained by two detection cells is defined as |I1+I2|ac.

The depth (the step) Hr of the pre-groove on the interface between the recording layer 103 and the light reflection layer 102 satisfying Expression (2) was simulated.

As a simulation condition, a track pitch Ptc (see FIG. 1) is fixed to 0.74 μm which is the same as that in the current DVD-R.

A trapezoidal shape is presumed like FIG. 1 as a cross-sectional shape of the pre-groove on the interface between the recording layer 103 and the light reflection layer 102, inclination angles of right and left slant surfaces of the pre-groove 107 are set to 50 degrees (when angles of 90 degrees are set in case of a vertical wall surface), and widths at the center of the slant surfaces are defined as a land width and a groove width.

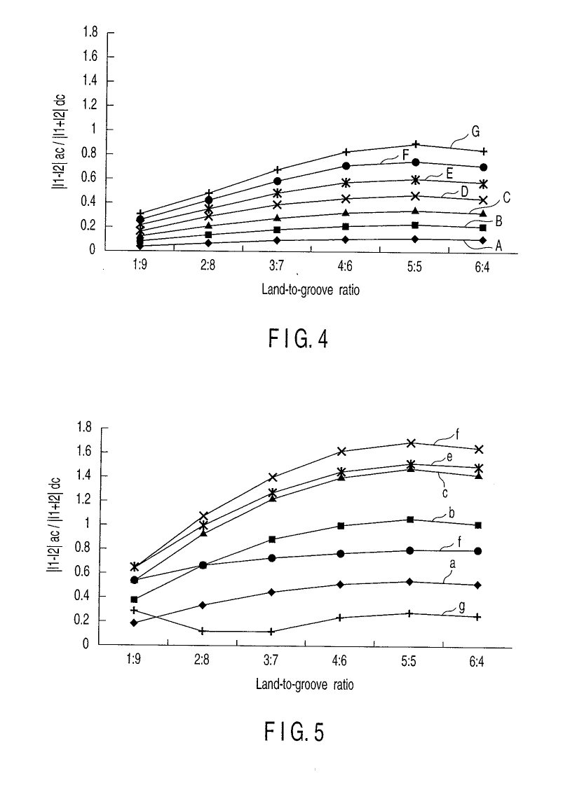

FIG. 4 is a view of a simulation result showing a relationship between the pre-groove depth Hr and the push-pull signal amplitude when the reproducing light having a wavelength of 650 nm is condensed by the objective lens having the NA of 0.60. It is to be noted that, in FIG. 4, curve A indicates an example where the groove depth is 10 nm, curve B indicates an example where the groove depth is 20 nm, curve C indicates an example where the groove depth is 30 nm, curve D indicates an example where the groove depth is 40 nm, curve E indicates an example where the groove depth is 50 nm, curve F indicates an example where the groove depth is 60 nm, and curve G indicates an example where the groove depth is 70 nm, respectively.

The ordinate in FIG. 4 represents the following formula in Expression (1):

|I1+I2|ac/|I1+I2|dc (7).

In FIG. 4, the pre-groove depth Hr is used as a parameter, and a value of Expression (7) when a ratio of the land width and the groove width at the center of each slant surface of the trapezoid is changed is calculated. A/W (A: a diameter of the objective lens, W: a diameter of a e⁻² width with respect to a central intensity in an incident light intensity distribution) indicative of a beam filling rate of incident light entering the objective lens is 0.3058 in a circumferential direction and 0.1513 in a radial direction.

FIG. 5 shows a simulation result when the recording light having a wavelength of 405 nm is condensed by the objective lens having the NA of 0.65 under the same conditions. It is to be noted that respective curves a to g indicate groove depths in FIG. 5 and they are associated with capital letters in FIG. 4.

In the example depicted in FIG. 5, A/W is 0.3331 in the circumferential direction and 0.3331 in the radial direction.

It can be understood that the far larger push-pull signal amplitudes can be obtained in FIG. 5 than those in FIG. 4.

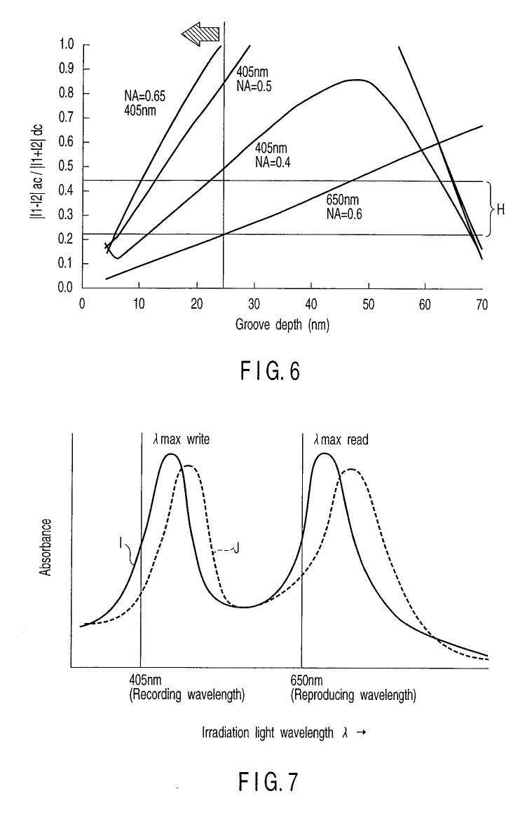

FIG. 6 shows the calculation result in FIG. 4 and the calculation result in FIG. 5 in a superimposing manner with an abscissa representing a groove depth.

The range of Expression (1) is “amplitude range conditions of a push-pull signal defined in the DVD-R standard” shown in a region “H” in FIG. 6.

It can be understood that setting the depth (the step) Hr of the pre-groove on the interface between the recording layer 103 and the light reflection layer 102 to 20 nm or below as a condition satisfying Expression (2) can suffice.

Further, it can be also perceived from FIG. 6 that the sufficiently large push-pull signal amplitude can be obtained based on the recording light with the wavelength of 405 nm which has passed through the objective lens having the NA of 0.65 even under this condition.

Incidentally, it can be understood from FIG. 6 that setting the depth (the step) Hr of the pre-groove on the interface between the recording layer 103 and the light reflection layer 102 to 10 nm or below as a condition satisfying Expression (3) can suffice.

FIG. 6 shows that, in a case where the recording light having the wavelength of 405 nm is applied with the NA of 0.65, the condition of Expression (1) is satisfied when the depth (the step) Hr of the pre-groove falls within the following range:

60 nm≦Hr≦100 nm (8).

Therefore, the range of the depth (the step) of the pre-groove is set to the range of Expression (8) in this embodiment.

A description will now be given on this embodiment concerning the recording layer 103 which has the structure depicted in FIG. 2 and in which information can be recorded with the recording light having a wavelength of 405 nm and a sufficiently large reproduction signal amplitude can be obtained from the recording mark 105 with the reproducing light having a wavelength of 650 nm.

The standard of a current reproduction-only DVD-ROM disc defines that a reflectivity with respect to the reproducing light having 650 nm when circular polarized light enters falls within the following range:

45 to 85% in a single layer; and

18 to 30% in multiple layers (9).

Furthermore, it also defines that a reflectivity with respect to the reproducing light having 650 nm when non-circular polarized light (linear polarized light) enters falls within the following range:

60 to 85% in a single layer; and

18 to 30% in multiple layers (10).

Therefore, a recording film is designed with respect to the information storage medium according to this embodiment in such a manner that the reflectivity for the producing light having 650 nm falls within the range of 45 to 85% (18 to 30% in case of multiple layers).

Specifically, this embodiment is characterized in that AgBi is used as a material of the light reflection layer 102 depicted in FIG. 2 in order to obtain the large light reflectivity.

In the embodiment of the present invention is not restricted thereto, and a silver alloy or silver alone may be used as a material of the light reflection layer 102.

Moreover, in regard to a degree of modulation of a reproduction signal from the recording mark 105 in the standard of the current DVD-ROM disc, a value I_{14H} when the largest reproduction signal can be obtained as seen from a “0 level” and a value I_{14L} when the smallest reproduction signal can be obtained are defined to satisfy the following expression:

(I_{14H}−I_{14L})/I_{14H}≧0.60 (11).

Therefore, in this embodiment, ingenuity is used with respect to characteristics of the recording film to satisfy Expressions (9) to (11).

FIG. 7 shows light absorption spectrums of an organic dye recording material used for the recording layer 103 according to this embodiment. It is to be noted that, in FIG. 7, a curve I represents absorption (absorbance) of the organic dye material before recording and a curve J (a dotted line) represents absorption (absorbance) of the organic dye material after recording.

This embodiment is significantly characterized in that the organic recording material which is recorded with the recording light having 405 nm is mixed (combined) with the organic recording material whose light reflection quantity varies based on the reproducing light having 650 nm in the recording mark 105.

As the organic recording material which is used in this embodiment and recorded by using the recording light having 405 nm, an L-to-H type recording material disclosed in Japanese Patent Application No. 2005-024303 by the present applicant is used.

As explained in the Application No. 2005-024303, characteristics lie in that the maximum absorption wavelength λₘₐₓ write of the organic recording material which is recorded by using the recording light having 405 nm is set larger than 405 nm, which is the wavelength of the recording light, to avoid degradation during reproduction or assure long-term preservation stability.

As show in FIG. 7, the absorbance of the recording material used in this embodiment after is lowered after recording as compared with that before recording with respect to light having a wavelength of 405 nm.

The light having 405 nm enters from the transparent substrate 101 side, passes through the recording layer 103, is reflected on the light reflection layer 102, and then returns via the recording layer 103.

A quantity of the reflected light which returns because of a reduction in light absorption in the recording mark 105 is increased (the reflected light quantity is H: High) in the middle of this light path as compared with that at other positions (the reflected light quantity is L: Low).

At this time, a hole is not formed in the recording mark 105, but an electron orbit varies in molecules due to a change in molecular arrangement or a small change in molecular configuration as explained in the Application No. 2005-024303, thereby changing optical characteristics.

A specific organic recording material in this embodiment is obtained by combining a hemicyanine cation with a material in which 10% of an azo dye which is not a metal complex to achieve high sensitivity is added in an azo Co complex anion (a kind of an azo metal complex) using Co (cobalt) as a central metal.

This embodiment is not restricted thereto, and it is possible to use a material obtained by combining a monomethine cyanine cation with a material in which 10% of the azo dye is added to the azo Co complex anion.

Further, as another application example, a styryl cation may be combined with a material in which 10% of the azo dye is added to the azo Co complex anion, or a single azo Cu complex using copper Cu as a central metal or a single azo Ni complex using nickel Ni as a central metal may be adopted.

Furthermore, as an organic recording material whose light reflection quantity varies based on the reproducing light having a wavelength of 650 nm, a material explained in Japanese Patent Application No. 2005-116466 by the present applicant may be used.

Moreover, this embodiment is characterized in that recording/reproduction characteristics are stabilized by matching a thermal structure changing temperature or decomposing temperature on a molecular level of the organic recording material whose light reflection quantity varies based on the reproducing light having the wavelength of 650 nm with that of the organic recording material recorded by using the recording light having the wavelength of 405 nm.

When forming the recording mark 105, a temperature of the organic recording material recorded by using the recording light having the wavelength of 405 nm is increased to provoke a change in molecular arrangement or a small change in molecular configuration. However, in accordance with this increase in temperature at this moment, a change in molecular arrangement or a small change in molecular configuration also occurs in the organic recording material whose light reflection quantity varies based on the reproducing light having the wavelength of 650 nm, thereby producing the principle of changing the light reflection quantity in the recording mark 105 with respect to the reproducing light having the wavelength of 650 nm.

Specifically, since the decomposing temperature of the organic recording material recorded by using the recording light of 405 nm is 230 to 250 degrees Celsius, the organic recording material whose light reflection quantity varies based on the reproducing light of 650 nm is adapted thereto.

As the organic recording material whose light reflection quantity varies based on the reproducing light of 650 nm, specifically, an azo Co complex anion is combined with a pentamethine cyanine cation in this embodiment.

Moreover, the present invention is not restricted thereto, and a single azo Cu complex may be used.

When the above-explained recording material is used, it is an L-to-H type recording material whose absorbance is lowered after recording as compared with that before recording with respect to the light having the wavelength of 650 nm.

Additionally, as shown in FIG. 7, when the maximum absorption wavelength λₘₐₓ read of the organic recording material whose light reflection quantity varies based on the reproducing light of 650 nm is set to a wavelength side longer than 650 nm, which is the wavelength of the reproducing light, the amplitude of a reproduction signal from the recording mark 105 in L-to-H type recording characteristics is distinctively increased.

In the current DVD-ROM disc, since the light reflection quantity is reduced in a recording pit part (an H-to-L type), recording processing is performed on the land 109 as finalizing processing after forming the recording mark 105 to achieve compatibility in this embodiment.

Further, the present invention is not restricted thereto, and recording may be carried out on the land 109 as a part of a characteristic inspection immediately after production of the information storage medium in a plant before shipping.

This embodiment is technically characterized in that increasing a mixing ratio (a weight percent) of the organic recording material whose light reflection quantity varies based on the reproducing light of 650 nm beyond that of the organic recording material recorded by using the recording light of 405 nm enables acquiring a large amplitude of a reproduction signal from the recording mark 105 based on the reproducing light of 650 nm.

In this embodiment, although the mixing ratio (the weight percent) of the organic recording material whose light reflection quantity varies based on the reproducing light of 650 nm beyond at least that of the organic recording material recorded by using the recording light of 405 nm, the most excellent recording/reproduction characteristics can be obtained when the following ratio is 7:3:

[a mixing ratio of the organic recording material whose light reflection quantity varies based on the reproducing light of 650 nm]:[a mixing ratio of the organic recording material recorded by using the recording light of 405 nm].

Furthermore, this embodiment is not restricted thereto, and the above-explained value may be set to 9:1.

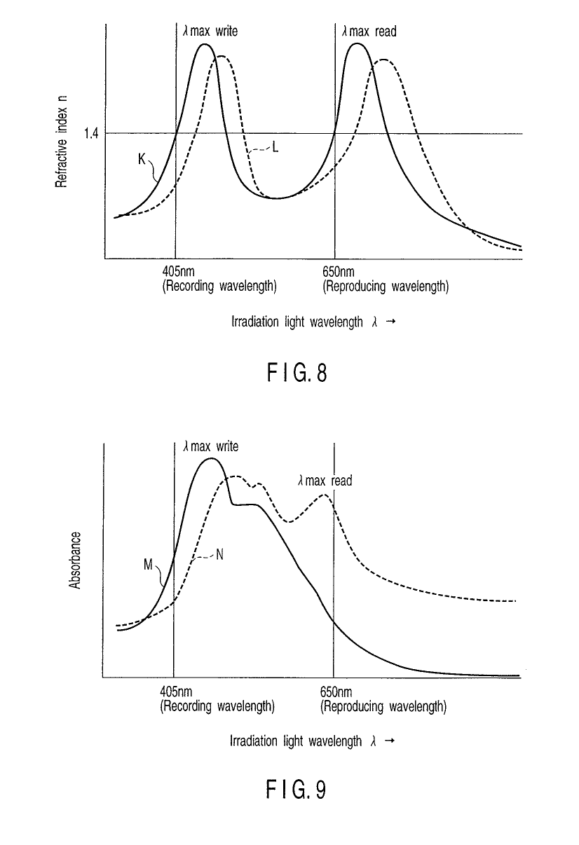

FIG. 8 shows refractive index characteristics of the L-to-H type organic dye material having the light absorption spectrums depicted in FIG. 7. It is to be noted that, in FIG. 8, a curve K indicates a refractive index of the organic dye material before recording and a curve L (a dotted line) indicates a refractive index of the organic dye material after recording.

It can be understood that the refractive index after recording is changed from that before recording with respect to the light having the wavelength of 650 nm.

In order to obtain such a large degree of modulation of the reproduction signal as shown in Expression (11), this embodiment also utilizes not only a change in absorbance depicted in FIG. 7 but also an interference phenomenon using a change in refractive index.

In FIG. 2, the reproducing light of 650 nm is reflected on not only the interface between the light reflection layer 102 and the recording layer 103 but also an interface between the recording layer 103 and the transparent substrate 101, and phases of the reflected lights on both the interfaces are greatly shifted from each other, thereby reducing a total light reflection quantity.

In the recording mark 105, since the refractive index is lowered as shown in FIG. 8, a phase shift amount between the reflected lights is reduced, and the total reflection light quantity is thereby increased.

In this embodiment, a thickness Dg of the recording layer 103 in the pre-groove 107 is optimized to demonstrate the above-explained effect.

As a result of conducting the experiment while changing the conditions, it was revealed that the largest amplitude of the detection signal from the recording mark 105 can be obtained when the thickness Dg of the recording layer Dg is 60 nm in the pre-groove 107 and the range of 30 to 90 nm is appropriate.

This embodiment is technically characterized in that a shape or a dimension of the pre-groove 107 or the land pre-pit 108 is optimized in accordance with the material of the recording layer 103.

In this embodiment, since the recording layer 103 is formed based on spinner coating, a thickness Dl of the recording layer 103 in the land 109 is smaller than the thickness Dg of the recording layer 103 in the pre-groove 107 as shown in FIG. 2.

Therefore, the depth (the step) Hg of the pre-groove 107 on the transparent substrate 101 for satisfying both the condition of Expression (8) and the range of Dg are set to fall within the range of 20 to 33 nm.

It was revealed from the experiment result that the large thickness Dg of the recording layer 103 cannot be obtained and amplitude of the reproduction signal from the recording mark 105 is reduced when the depth (the step) Hg of the pre-groove 107 on the transparent substrate 101 is set to 15 nm or below.

Furthermore, as pointed out in the section of the problems in the conventional technology, when the DC level from the pre-groove 107 during reproduction is lowered, a problem of a decrease in an amplitude of the reproduction signal from the recording mark occurs.

To solve this problem, a width Wgc of the pre-groove 107 is set to 250 to 308 in this embodiment.

Although not shown in this embodiment, the pre-groove 107 is wobbled to facilitate rotation synchronization or signal synchronization.

When this wobbled amplitude is too large, it adversely affects characteristics of the reproduction signal from the recording mark 105.

In this embodiment, the wobbled amplitude is set to 15 nmp-p or below (5 nmp-p is most appropriate), thereby excellently maintaining characteristics of the reproduction signal from the recording mark 105 (stabilizing characteristics of the reproduction signal).

Furthermore, as pointed out in the section of the problems in the conventional technology, mixing of a crosstalk signal from the land pre-pit 108 adversely affects characteristics of the reproduction signal from the recording mark 105.

Therefore, a technical ingenuity is made with respect to a shape and a dimension of the land pre-pit 108 in order to reduce mixing of the crosstalk signal from the land pre-pit 108 in this embodiment.

As shown in FIGS. 1 and 10A, in the current DVD disc, the land pre-pit 108 is formed into the irregular pit shape.

In this case, since a change in signal (including wobbling back) at a boundary part of the pit is large, an influence of crosstalk is serious.

On the other hand, in this embodiment, as shown in FIG. 10B, a part of the pre-groove 107 is formed to meander, thereby forming the land pre-pit 108.

As a result, an amount of a change in signal at positions near the land pre-pit 108 can be appropriately controlled to excellently maintain characteristics of the reproduction signal from the recording mark 105.

In this embodiment, a meandering length Lpc of the pre-groove 107 in the land pre-pit 108 is set to 40 nm, and a meandering amplitude Wpc is set to 300 nm.

FIG. 9 shows light absorption spectrums when another embodiment of the organic recording material adopted for the recording layer 103 in the present invention is used. It is to be noted that, in FIG. 9, a curve M indicates absorption (absorbance) of the organic dye material before recording and a curve N (a dotted line) indicates absorption (absorbance) of the organic dye material after recording.

The H-to-L type recording material is used as the organic recording material recorded by using the recording light of 405 nm, and a thermosensitive dye material which is blackened at a recording position is used as the organic recording material whose light reflection quantity varies based on the reproducing light of 650 nm.

When the thermo-sensitive dye material is used, it serves as the H-to-L type recording material whose absorbance is greatly increased after recording with a wavelength 650 nm of the reproducing light to reduce a reflected light quantity of the reproducing light.

Another embodiment depicted in FIG. 9 is characterized in that an amount of a change in absorbance before and after recording is increased to satisfy the condition of Expression (11) by setting the maximum absorption wavelength λₘₐₓ read of the organic recording material whose light reflection quantity varies based on the reproducing light of 650 nm after recording to be smaller than 650 nm, which is a wavelength of the reproducing light.

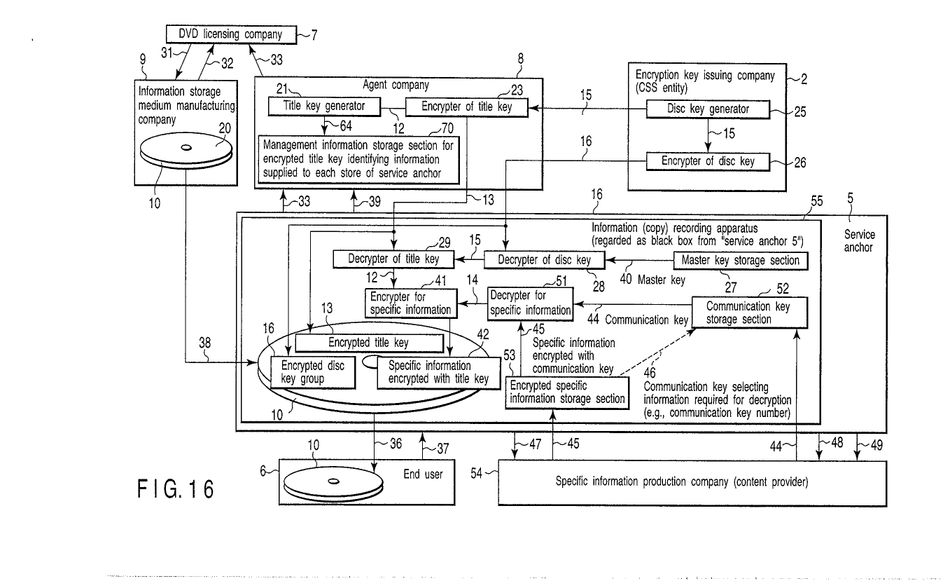

The information storage medium according to the present invention is utilized in network distribution for picture information as shown in FIG. 16.

Encrypted specific information 45 (picture content 11) transferred from a specific information production company (a content provider) 54 via a network is recorded in an information storage medium 10 by using recording light of 405 nm in an information (copy) recording apparatus 55 in a service anchor 5.

An end user 6 uses reproducing light of 650 nm to reproduce the picture content 11 from the information storage medium 10 having the information recorded therein in this manner.

In the embodiments of the present invention assumes the following two methods as a method of using the information storage medium.

One method is a method of distributing the encrypted specific information 45 (the picture content) 11 to the service anchor 5 through the network as shown in FIG. 16 so that the specific information 45 is recorded in the information storage medium 10 in the service anchor 5, and it is called Manufacturing on Demand (MOD).

Moreover, the other method is a method of directly distributing the specific information 45 to the end user 6 and using the recording light of 405 nm in the recording apparatus owned by the end user 6 to record the specific information 45 in the information storage medium 10, and it is called Electronic Sell Through (EST).

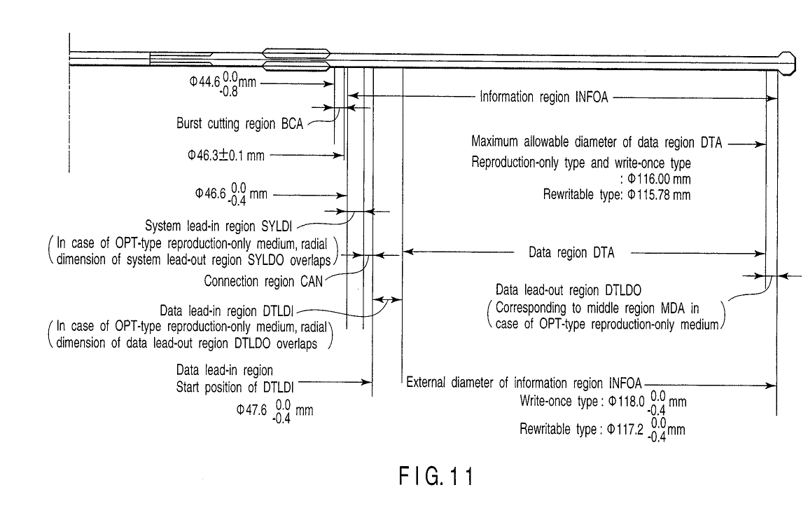

FIG. 11 shows a macroscopic structure in the information storage medium according to this embodiment.

A track pitch and a line density of a system lead-in region SYLDI are higher (approximately twofold) than those of a data lead-in region DTLDI.

In this embodiment, the recording mark 105 is formed in each of the system lead-in region SYLDI and the data lead-in region DTLDI by using the recording light of 405 nm after forming the information storage medium, thereby recording information.

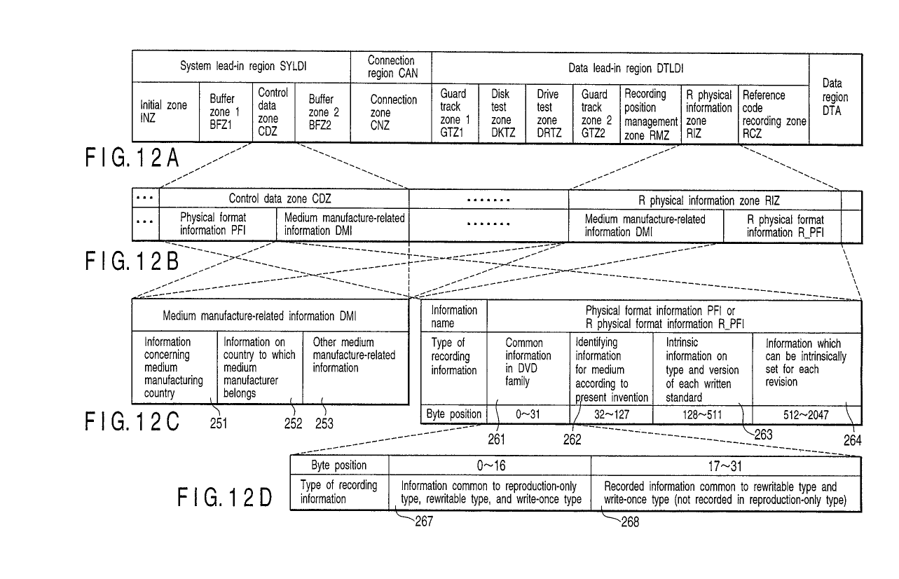

A control data zone CDZ can be recorded in the system lead-in region SYLDI as shown in FIGS. 12A and 12B, and identifying information 262 for the medium according to the present invention can be recorded in a region extending from a 32nd byte to a 127th byte as byte positions in physical format information PFI in this zone.

Additionally, intrinsic information 263 of a type and a version of each written standard and information contents 264 which can be set in accordance with each revision can be recorded, and recording conditions (a write strategy) at the time of recording information in the information storage medium 10 by using the recording light of 405 nm can be recorded in the information contents 264 which can be set in accordance with each revision.

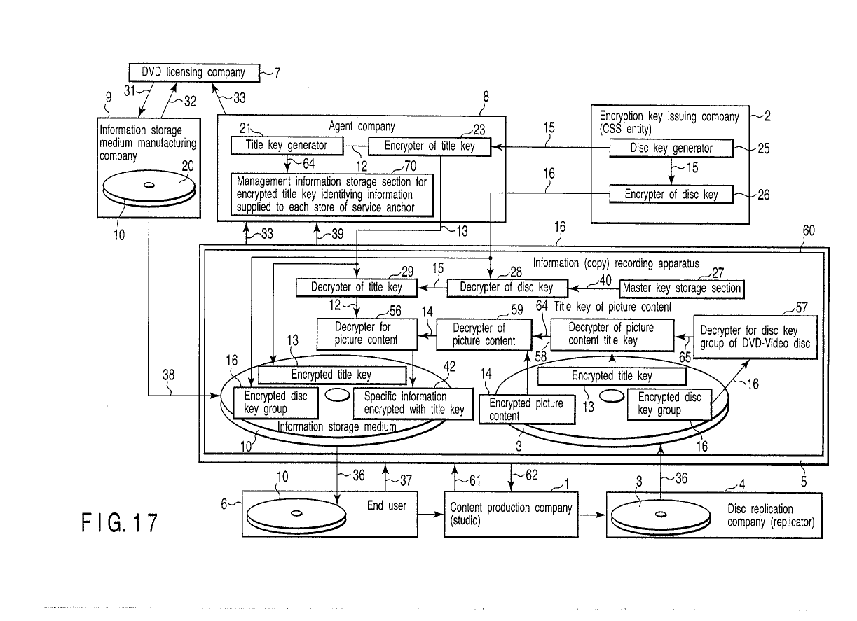

As shown in FIG. 16 or 17, an information storage medium manufacturing company 9 sells the information storage medium 10 which is in a blank state 20.

In this embodiment, when the MOD method is used, information in the system lead-in SYLDI (including the physical format information PFI in the control data zone CDZ) depicted in FIGS. 12A and 12B are not recorded in the information storage medium 10 in the blank state 20, and the information storage medium 10 is sold in this state.

According to this method, since the information storage medium manufacturing company 9 does not require a cost of recording in the information storage medium 10 the information in the system lead-in SYLDI (including the physical format information PFI in the control data zone CDZ), it can sell the information storage medium 10 in the blank state 20 at a low price to the service anchor 5.

In case of MOD, the recording conditions (the write strategy) when recording information by using the recording light of 405 nm are recorded in the land pre-pit 108 in advance.

In case of MOD, since the information (copy) recording apparatus 55 having excellent reproduction performance with respect to the information previously recorded in the land pre-pit 108 is used, thus assuring stability of reproducing the information from the land pre-pit 108.

On the other hand, when EST is used, stability of reproducing the information from the land pre-pit 108 in the recording apparatus owned by the end user 6 cannot be assured.

Therefore, in this embodiment, the information of the control data zone CDZ (and the system lead-in region SYLDI including this zone) including the physical format information PFI in which the recording conditions (the write strategy) when recording information by using the recording light of 405 nm is recorded in the information storage medium 10 in the blank state 20, and the information storage medium 10 having this information recorded therein is sold.

Since reliability of reproduction from the information (the recording mark 105) recorded by using the recording light of 405 nm is high, reliability of acquiring the information of the recording conditions (the write strategy) used in EST can be greatly improved according to this embodiment.

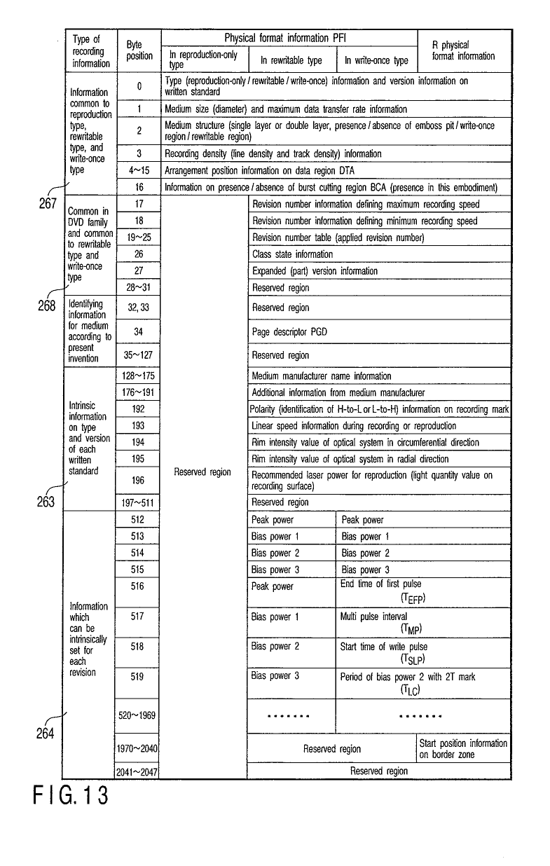

FIG. 13 shows detailed information contents in the physical format information PFI depicted in FIG. 12C.

It is assumed that information in the information storage medium according to the present invention can be reproduced by a current DVD player.

Therefore, this embodiment is characterized in that the identifying information indicating whether a medium is a current reproduction-only DVD ROM disc, a current write-once DVD-R disc, or the information storage medium according to the present invention is provided in the physical format information PFI so that the recording apparatus or the reproduction apparatus can stably operate.

In the embodiment depicted in FIG. 13, a page descriptor PGD is arranged at a 34th byte position in a recording region of the identifying information 262 for the medium according to the present invention.

This page descriptor PGD indicates a current reproduction-only DVD-ROM disc or a current write-once DVD-R disc when PGD is 00h;

it means that the information storage medium according to the present invention is used based on MOD when PGD is 10h; and

it means that the information storage medium according to the present invention is used based on EST when PGD is 11h.

As a result, a disc in the recording apparatus or the reproducing apparatus can be readily discriminated at a high speed, and simplification and stabilization of recording/reproducing processing can be assured.

As shown in FIG. 13, the recording conditions (the write strategy) when recording by using the recording light of 405 nm can be recorded at a 512th byte position and subsequent positions in a region of the information contents 264 which can be intrinsically set in accordance with each revision.

In the current write-once DVD-R disc, the recording conditions (the write strategy) which vary depending on a type of the information storage medium can be recorded in the same region by enabling recording the recording conditions (the write strategy) when recording by using the light of 650 nm in this region, thus effectively utilizing the region in the physical format information PFI.

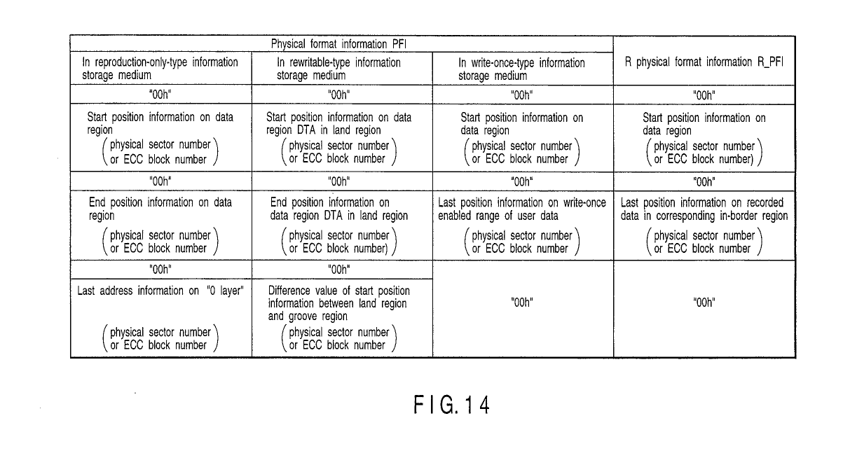

Furthermore, FIG. 14 shows information contents in arrangement position information of the data region DTA depicted in FIG. 13.

Information which is common in the “write-once information storage medium is recorded in the information recording medium according to this embodiment is liked the current DVD-R disc.

As a method of providing the identifying information indicative of the current reproduction-only DVD-ROM disc, the current write-once DVD-R disc, or the information storage medium according to the present invention in the physical format information PFI, “type information and version number information of a written standard” which are shown not only in FIG. 14 but also at a 0th byte position in FIG. 13 may be utilized (a version number may be substituted by a current value) to provide the identifying information and also provide identifying information indicative of using MOD or EST in another embodiment according to the present invention.

Moreover, as still another embodiment, specific values may be set in revision number information, a revision number table, class state information, or expanded (part) version information provided at 17th to 27th byte positions in FIG. 13 to provide the identifying information indicative of the information storage medium according to the present invention and that indicative of use of MOD or use of EST.

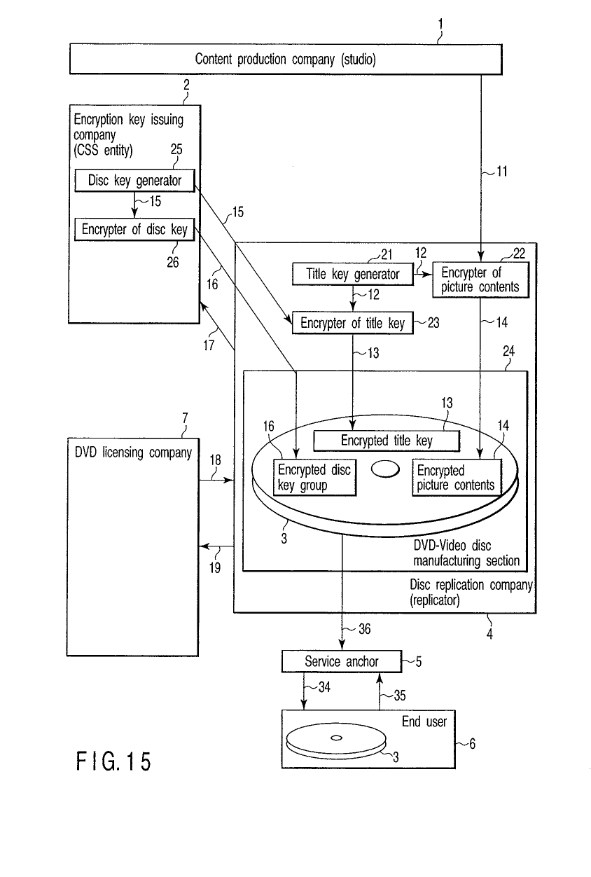

Information contents recorded in a current DVD-Video disc and its forming position will now be explained with reference to FIG. 15.

In the current DVD-Video disc, encryption processing using a CSS mode is carried out as a function of avoiding illegal copy of picture information.

Picture content 11 produced by a content production company (a studio) 1 is distributed to a disc replication company (a replicator) 4 by using a tape as a medium or based on network transfer.

When avoiding illegal copy of the picture content 11, the distributed picture content 11 itself is not recorded in a DVD-Video disc 3, but encrypted picture content 14 obtained by encrypting the picture content 11 with a title key 12 is recorded in the DVD-Video disc 3.

This encryption processing is carried out in a picture content encrypter 22 present in the disc replication company (the replicator) 4, and the title key 12 used for encryption is also issued in a title key generator 21 present in the disc replication company (the replicator) 4.

Additionally, the disc replication company (the replicator) 4 receives disc key information 15 and information of an encrypted disc key group 16 with a fee (with a key fee 17) from a CSS entity 2 which is an en encryption key issuing company, and records this information of the encrypted disc key group 16 in the DVD-Video disc 3.

Further, it encrypts the title key 12 by utilizing the information of the disc key 15 received from the CSS entity 2, and also records an encrypted title key 13 in the same DVD-Video disc 3.

In the current DVD-Video disc, the encrypted disc key group 16 is recorded in a leak-in region (in the control data zone CDZ depicted in FIGS. 12A and 12B in the system lead-in region SYLDI shown in FIG. 11), and information concerning the encrypted title key 13 is decentralized and arranged in specific positions in a physical sector as a basic recording unit of the DVD-Video disc 3 and recorded at these positions.

Furthermore, the disc replication company (the replicator) 4 pays a DVD licensing fee 19 to a DVD licensing company 7 every time it manufactures the DVD-Video disc 3, thus obtaining a DVD-Video disc manufacturing licensed right 18.

An end user 6 pays a purchase price 35 to purchase the DVD-Video disc 3 in which the encrypted disc key group 16, the encrypted title key 13, and the encrypted picture content 14 is recorded.

Although not shown in a DVD player as the reproduction apparatus owned by the end user 6, a master key is used to decrypt the disc key, and the encrypted picture content 14 is restored to the non-encrypted picture content 11 to be reproduced and displayed by utilizing the title key 12 produced (decrypted) by using the decrypted disc key.

The encrypted disc key group 16, the encrypted title key 13, and the encrypted picture content 14 is recorded as pits having fine irregular shapes in the current DVD-Video disc 3, whereas this embodiment is greatly characterized in that they are recorded in the information storage medium 10 as the recording marks 105 formed by using the recording light having a wavelength λw and encrypted specific information 45 (the encrypted picture content 14) as information concerning the picture content 11 and encryption related information concerning the CSS mode are distributed through a network.

CPRM is used as an encryption mode for avoiding illegal copy in the DVD-R disc which is the current write-once information storage medium, whereas this embodiment is greatly characterized in that the information concerning CSS depicted in FIG. 15 is recorded in the information storage medium 10.

That is, although a pit having an irregular shape is not formed but each recording mark 105 is formed in the information storage medium according to this embodiment having the information recorded therein by using the recording light with the wavelength of λw, this information storage medium is recognized by the DVD player (the reproduction apparatus) to enable reproduction as if it is the DVD-Video disc manufactured as shown in FIG. 15.

Therefore, in the information storage medium according to this embodiment having the information recorded therein by using the recording light having the wavelength λw, the encrypted disc key group 16 (recorded in the control data zone CDZ in the system lead-in region SYLDI depicted in FIGS. 12A and 12B) which is the information concerning CSS, the encrypted title key 13, and the encrypted picture content 14 is recorded.

Moreover, this embodiment is also characterized in that information indicative of a “reproduction-only medium (a DVD-ROM disc)” is written in the physical format information PFI (or R-PFI) in the control data zone CDZ depicted in FIGS. 12A to 12D in order to enable the existing DVD player (the reproduction apparatus) to recognize the information storage medium as if it is the reproduction-only DVD-Video disc.

As a result, the information recorded in the information storage medium 10 according to the embodiment of the present invention can be stably reproduced without imposing a burden on the DVD player (the reproduction apparatus) at all.

Specifically, in this embodiment, a written standard type is set to “0000b” in “type information and version number information of a written standard” recorded at the 0th byte position in FIG. 13, thus specifying a DVD-ROM written standard.

Even if the written standard type is specified in this manner, using the information in the page descriptor PGD depicted in FIG. 13 enables identification of the information storage medium according to this embodiment or the genuine DVD-ROM disc.

Additionally, although presence/absence of an emboss pit and a write-once region or a rewritable region is specified in a medium structure recorded at a second byte position in FIG. 13, values of “b2, b1, and b0” are set to “001” to clearly specify the medium structure with respect to the DVD player (the reproduction apparatus) as if it is a structure having the emboss pit alone.

Information of the medium structure means that a rewritable user region is not provided in a corresponding information storage medium when b2=0b; and

it means that the rewritable user region is provided in a corresponding information storage medium when b2=1b.

Further, this information means that a write-once user region is not provided in a corresponding information storage medium when b1=0b; and

it means that the write-once user region is provided in a corresponding information storage medium when b1=1b.

Furthermore, this information means that a user region having an emboss pit formed therein is not provided in a corresponding information storage medium when b0=0b; and

it means that the user region having the emboss pit formed therein is provided in a corresponding information storage medium when b0=1b.

The encrypted disc key group 16, the encrypted title key 13, and the encrypted picture content 14 is recorded in the information storage medium 10 used in the MOD method by the information (copy) recording apparatus 55 installed in the service anchor 5, whilst the encrypted disc key group 16, the encrypted title key 13, and the encrypted picture content 14 is recorded in the information storage medium used in the EST method by the recording apparatus owned by the end user 6.

In any case, according to this embodiment, information concerning the CSS related information and specific information, e.g., the picture content 14 is distributed to the recording apparatus through a network.

The specific information, e.g., the picture content 14 may be illegally copied during distribution through the network, or the encrypted specific information 42 (the encrypted picture content 14) recorded in the information storage medium 10 may be illegally decrypted when various kinds of key information concerning CSS are stolen, and hence the risk of illegal copy is increased.

To solve this problem, this embodiment is significantly characterized in that the specific information, e.g., the picture content 14 and various kinds of key information concerning CSS are all encrypted and then distributed through the network.

As a result, even if information leaks through the network, the leaked information is not non-decrypted (plain) information but necessarily encrypted information, and hence it cannot be reused, thus leading to an effect of avoiding illegal copying.

Characteristics of this embodiment will now be explained in detail with reference to FIG. 16.

As explained above, information is recorded in the information storage medium 10 used in the MOD method by light having a recording wavelength λw (≠650 nm) in the information (copy) recording apparatus 55 installed in the service anchor 5.

A communication key storage section 52 and a master key storage section 27 are present in this information (copy) recording apparatus 55.

Although these sections look different from each other in FIG. 16, the present invention is not restricted thereto, and both the communication key storage section 52 and the master key storage section 27 may be used in a single memory.

The service anchor 5 pays a communication key fee 49 to a production company (a content provider) 54 of the specific information, e.g., the picture content 11 to purchase a communication key 44.

The production company (the content provider) 54 of the specific information utilizes this communication key to encrypt the specific information, e.g., the picture content 11, and distributes specific information 45 encrypted with the communication key to the service anchor 5 through the network.

Furthermore, when the service anchor 5 sells the information storage medium 10 in which this specific information is encrypted and recorded to the end user 6, it pays a replication permission fee 47 according to its earnings to the production company (the content provider) 54 of the specific information.

The specific information 45 encrypted by using the communication key distributed from the specific information production company (the content provider) 54 is once decrypted in a decrypter for the specific information by utilizing information of the already distributed communication key 44.

Immediately after this, this information is encrypted by using the title key 12 and recorded in the information storage medium 10 in the form of specific information 42 encrypted with the title key.

In the current example depicted in FIG. 15, although a disc key 15 is transferred between the encryption key issuing company (the CSS entity) 2 and the disc replication company (the replicator) 4, it is transferred in an environment where a sufficient security measure is taken with respect to this path. As compared with this, in a network path of a system depicted in FIG. 16, a security measure is not sufficient, and the disc key 15 is in danger of leaking to the outside in this path.

On the other hand, in the embodiment shown in FIG. 16, the encrypted title key 13 is transferred to the service anchor 5 through the network in place of the plain (non-encrypted) disc key 15.

In order to realize this, according to this embodiment, an agent company 8 is arranged between the encryption key issuing company (the CSS entity) 2 and the service anchor 5.

This agent company 8 issues the title key 12 for each title from the title key generator 21.

Then, the title key 13 encrypted by using the disc key 15 transferred from the encryption key issuing company (the CSS entity) 2 in the environment where the sufficient security measure is taken is generated in an encrypter 23 of the title key and distributed to the service anchor 5 through the network.

In the information (copy) recording apparatus 55 in the service anchor 5, the encrypted title key 13 distributed through the network is recorded in the information storage medium 10 as it is.

The service anchor 5 pays a key fee and a DVD licensing fee 33 to the agent company 8 in accordance with the number of times of recording the title key 13 recorded in the information storage medium 10.

The agent company 8 pays the collected DVD licensing fees 33 in a lump sum to the DVD licensing company 7.

Moreover, the DVD licensing company 7 gives the information storage medium manufacturing licensed right 31 to the information storage medium manufacturing company 9 which manufactures the information storage medium 10 in the blank state 20 in place of collecting a DVD licensing fee 32.

The agent company 8 shown in FIG. 16 receives the disc key 15 and the encrypted disc key group 16 from the encryption key issuing company (the CSS entity) 2 like the disc replication company (the replicator) 4, but the agent company 8 directly distributes the encrypted disc key group 16 to the service anchor through the network.

Since the information distributed to the service anchor 5 through the network in this manner is all encrypted information, i.e., the “specific information 45 encrypted with the communication key”, the “encrypted disc key group 16”, and the “encrypted title key”, illegal copy can be avoided even if the information leaks in the network path.

Although FIG. 16 illustrates the information storage medium 10 used in the MOD method, the present invention is not restricted thereto, and it can be also applied to the information storage medium 10 used in the EST method.

In case of EST, although a distribution target through the network is the end user 6, all encrypted information, i.e., the “specific information 45 encrypted with the communication key”, the “encrypted disc key group 16”, and the “encrypted title key” are likewise distributed to the end user 6 even in this case, thus avoiding illegal copy.

It is to be noted that, in both MOD and EST, since the information concerning SCC distributed through the network matches with the information recorded in the information storage medium 10, i.e., the “encrypted disc key group 16” and the “encrypted title key”, processing before recording in the information (copy) recording apparatus 55 can be greatly simplified to reduce a price of the information (copy) recording apparatus 55 and improve reliability of the processing.

Additionally, the decrypter 28 for the disc key in the information (copy) recording apparatus 55 utilizes a master key 40 transferred from the master key storage section 27 to decrypt the encrypted disc key group 16 distributed from the agent company 8 through the network.

The decrypter 29 for the title key utilizes the thus obtained disc key 15 to decrypt the encrypted title key 13 likewise distributed from the agent company 8 through network, and produces the title key 12. This title key 12 is used to encrypt the specific information 43 in the encrypter 41 for the specific information, and the encrypted specific information is recorded in the information storage medium 10.

FIG. 17 shows another embodiment according to the present invention.

In FIG. 17, like the embodiment depicted in FIG. 16, CSS related information distributed to an information (copy) recording apparatus 60 through a network is encrypted information recorded in an information storage medium 10, i.e., “encrypted disc key group 16” and “encrypted title key”.

The embodiment shown in FIG. 17 is different from the above example in that a regular DVD-Video disc 3 is subjected to distribution 36 in place of distributing the picture content 11 through the network.

In the embodiment depicted in FIG. 17, encrypted picture content 14 recorded in this DVD-Video disc 3 is decrypted (decoded) in the information (copy) recording apparatus 60, and the decrypted picture content 14 is again encrypted and recorded in the information storage medium 10 according to the present invention.

As explained above, according to the information recording medium of the present invention, the recording light which is used to form the recording mark and the reproducing light which is used to reproduce the recording mark are lights having different wavelengths, thereby stably effecting recording processing and reproduction processing.

Further, according to the information recording medium of the present invention, in the recording film including the recording layer and the light reflection layer, the pre-groove having the irregular shape and the land sandwiched between the pre-grooves adjacent to each other are defined on the interface between the recording layer and the light reflection layer, the recording film has the light reflectivity which enables reproduction with the light of 650±5 nm, the recording layer has the recording sensitivity with respect to light having a wavelength shorter than 650±5 nm, and the recording mark can be formed on the pre-groove based on the light having a wavelength shorter than 650±5 nm. Therefore, the track deviation detection signal and the land pre-pit detection signal can be obtained with respect to the recording light. When the shape and the dimension of the pre-groove and those of the land pre-pit are set so that the reproducing light is hardly affected by the pre-groove or the pre-pit, the recording processing and the reproduction processing can be further stabilized.

It is to be noted that the present invention is not restricted to any of the foregoing embodiments as it is, but constituent elements can be modified and embodied without departing from the scope thereof on an embodying stage. Furthermore, various kinds of inventions can be formed by appropriately combining a plurality of constituent elements disclosed in any of the foregoing embodiments. For example, some constituent elements can be deleted from all the constituent elements disclosed in the embodiments. Moreover, constituent elements used in the different embodiments can be appropriately combined.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information storage medium comprising:
a recording film comprising a recording layer and a light reflection layer;
pre-grooves, and
a plurality of lands, each of which is sandwiched between the pre-grooves and positioned adjacent to each other, the pre-grooves and the lands being forming on an interface between the recording layer and the light reflection layer,
wherein the recording film includes a light reflectivity that enables reproduction with light of 650±5 nm, wherein the recording layer includes a recording sensitivity with respect to light with a wavelength shorter than 650±5 nm, and wherein a recording mark is configured to be formed on the pre-groove by using light of a wavelength shorter than 650±5 nm.

2. The information storage medium of claim 1, wherein the pre-groove depth is smaller than 650/(16·n₆₅₀) nm, where n₆₅₀ is a refractive index in the recording layer with respect to the light of 650±5 nm.

3. A method of recording information in a storage medium, the method comprising applying a recording mark to a storage medium, wherein the storage medium comprises a recording film that comprises a recording layer and a light reflection layer; pre-grooves, and a plurality of lands each of which is sandwiched between the pre-grooves and positioned adjacent to each other, the pre-grooves and the lands being formed on an interface between the recording layer and the light reflection layer, wherein the recording film includes a light reflectivity that enables reproduction with light of 655±5 nm, wherein the recording layer has a recording sensitivity with respect to light with a wavelength shorter than 655±5 nm, and wherein the recording mark is configured formed on the pre-groove of the recording layer by using light of a wavelength shorter than 650±5 nm.

4. The method of claim 3, wherein the pre-groove depth is smaller than 650/(16·n₆₅₀) nm, where n₆₅₀ is a refractive index in the recording layer with respect to the light of 650±5 nm.

5. A method of reproducing information from a storage medium, the storage medium comprising a recording film that comprises a recording layer and a light reflection layer, the storage medium further comprising pre-grooves and lands each of which lands is sandwiched between the pre-grooves adjacent to each other, the pre-grooves and the lands being formed on an interface between the recording layer and the light reflection layer, wherein the recording film includes a light reflectivity that enables reproduction with light of 650±5 nm, wherein the recording layer includes a recording sensitivity with respect to light by a wavelength shorter than 655±5 nm, a recording mark is formed on the pre-groove of the recording layer by using light with a wavelength shorter than 650±5 nm, the method comprising reproducing information recorded on the recording film by using the light of 650±5 nm.

6. The method of claim 5, wherein the pre-groove depth is smaller than 650/(16·n₆₅₀) nm, where n₆₅₀ is a refractive index in the recording layer with respect to the light of 650±5 nm.
